(19) United States
(12) Patent Application Publication
(10) Pub. No.: US 2024/0271477 A1
(43) Pub. Date: Aug. 15, 2024

(54) AUTOMATED DOOR CONTROL BY AN AUTONOMOUS VEHICLE

(71) Applicant: GM Cruise Holdings LLC, San Francisco, CA (US)

(72) Inventors: Rajat Basu, Sunnyvale, CA (US); Shahram Rezaei, Danville, CA (US)

(21) Appl. No.: 18/168,987

(22) Filed: Feb. 14, 2023

(51) Int. Cl. E05F 15/75; B60W 50/14; B60W 60/00; E05F 15/79

(52) U.S. Cl. CPC E05F 15/75; B60W 50/14; B60W 60/00253; E05F 15/79; B60W 2420/403; B60W 2540/049; E05F 2015/767; E05Y 2400/44; E05Y 2400/45; E05Y 2400/814; E05Y 2900/531

(57) ABSTRACT

Systems and techniques are provided for automated door opening and automated door closing in an autonomous vehicle (AV). An example method can include sending a first signal to at least one automatic door actuator for opening at least one door of an autonomous vehicle (AV), wherein the at least one door gives access to the AV to one or more passengers for a ridehail service provided by the AV: determining, based on data received from at least one AV sensor, that the one or more passengers are seated within the AV; and in response to determining that the one or more passengers are seated within the AV, sending a second signal to the at least one automatic door actuator for closing the at least one door of the AV.

### BACKGROUND

### 1. Technical Field

The present disclosure generally relates to autonomous vehicles and, more specifically, to controlling an automated door system by an autonomous vehicle.

### 2. Introduction

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at fixed locations on the autonomous vehicles.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 is a diagram illustrating an example system environment that can be used to facilitate autonomous vehicle (AV) navigation and routing operations, in accordance with some examples of the present disclosure;

FIG. 2 is a diagram illustrating an example system for implementing automated door control in an autonomous vehicle, in accordance with some examples of the present disclosure:

FIG. 3 is a diagram illustrating an example of an active seating system that may be used for implementing automated door control in an autonomous vehicle, in accordance with some examples of the present disclosure;

FIG. 4 is a diagram illustrating an example of active seating system measurements that may be used for automated door control in an autonomous vehicle, in accordance with some examples of the present disclosure:

FIG. 5 is a flowchart illustrating an example process for implementing automated door control in an autonomous vehicle, in accordance with some examples of the present disclosure; and

FIG. 6 is a diagram illustrating an example system architecture for implementing certain aspects described herein.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form in order to avoid obscuring the concepts of the subject technology.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Autonomous vehicles (AVs), also known as self-driving cars, driverless vehicles, and robotic vehicles, are vehicles that use sensors to sense the environment and move without human input. For example, AVs can include sensors such as a camera sensor, a LIDAR sensor, and/or a RADAR sensor, amongst others, which the AVs can use to collect data and measurements that are used for various AV operations. The sensors can provide the data and measurements to an internal computing system of the autonomous vehicle, which can use the data and measurements to control mechanical systems of the autonomous vehicle, such as a vehicle propulsion system, a braking system, and/or a steering system, etc.

In some cases, an autonomous vehicle may be used to provide ridehailing services (e.g., pick-up and drop-off of passengers). In some examples, the autonomous vehicle may be configured with automatic doors that are able to open and close without user intervention. That is, the autonomous vehicle can cause one or more doors to open for the purpose of picking up or dropping off passengers. Likewise, the autonomous vehicle can cause one or more doors to close after passengers have boarded the vehicle and/or after passengers have disembarked.

In some instances, causing an automated door to open or close can present challenges. For example, the autonomous vehicle must ensure that all passengers are safely aboard the autonomous vehicle prior to causing the doors to close. However, waiting too long to close the doors may be inefficient, cause safety issues, and/or frustrate passengers that are aboard and ready to go. Similarly, the autonomous vehicle must ensure that the area is clear prior to causing one or more doors to open. Also, additional safety concerns may be present if a door is opened while a passenger is asleep.

Systems and techniques are provided herein for controlling automated doors on an autonomous vehicle. In some aspects, an autonomous vehicle may use one or more sensors to determine that passengers are safely aboard. For example, the autonomous vehicle may use seat occupancy sensors, seatbelt sensors, in-cabin cameras, inertial measurement units (IMUs), active seating systems, and/or any combination thereof to determine that passengers have boarded prior to causing an automated door to close.

In some cases, the autonomous vehicle may also confirm that the number of passengers aboard corresponds to the number of passengers associated with a ridehailing request. For instance, the autonomous vehicle may use sensor data (e.g., seat occupancy sensors) to count the number of passengers aboard the vehicle and compare that number to the number of passengers indicated by the ridehailing request.

In some aspects, the autonomous vehicle may implement a boarding timer. In some cases, the boarding timer may be initiated after the door is automatically opened. In some aspects, the boarding timer may be different depending on the number of passengers. For example, a ridehailing request associated with a single passenger may have a corresponding boarding timer that is shorter than a ridehailing request that is associated with three passengers. In some cases, the autonomous vehicle may issue an alert when the boarding timer has expired to warn passengers and/or bystanders that an automated door will be closing.

In some cases, the autonomous vehicle can determine whether one or more passengers are asleep. For example, the autonomous vehicle can use data from in-cabin cameras and/or IMUs to determine whether a passenger is asleep. In some instances, the autonomous vehicle may provide a wake-up alert to the passenger prior to arriving at the final destination and/or prior to opening an automated door. In some example, the wake-up alert may be provided using an active seating system that causes the passenger's seat to move or vibrate. In another example, the wake-up alert may include changing the volume of in-cabin entertainment, turning on one or more lights, enabling an odorization system, sending a command to a client device, etc.

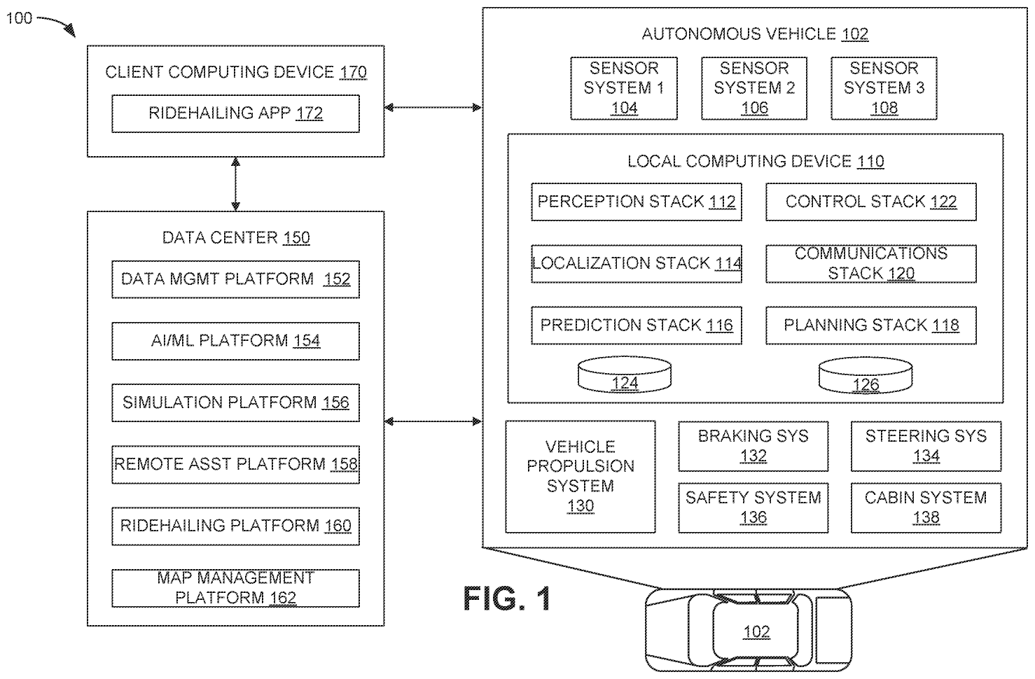

FIG. 1 is a diagram illustrating an example autonomous vehicle (AV) environment 100, according to some examples of the present disclosure. One of ordinary skill in the art will understand that, for the AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more in client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the perception stack 112 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (Saas) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridehailing service (e.g., a ridesharing service), a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridehailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridehailing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridehailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridehailing platform 160, the map management platform 162, and other platforms and systems. Using the AI/ML platform 154, data scientists can prepare data sets from the data management platform 152; select, design, and train machine learning models; evaluate, refine, and deploy the models: maintain, monitor, and retrain the models; and so on.

The simulation platform 156 can enable testing and validation of the algorithms, machine learning models, neural networks, and other development efforts for the AV 102, the remote assistance platform 158, the ridehailing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridehailing platform 160 can interact with a customer of a ridehailing service via a ridehailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridehailing application 172. The client computing device 170 can be a customer's mobile computing device or a computing device integrated with the AV 102 (e.g., the local computing device 110). The ridehailing platform 160 can receive requests to pick up or drop off from the ridehailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view; query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridehailing platform 160 may incorporate the map viewing services into the ridehaling application 172 to enable passengers to view the AV 102 in transit en route to a pick-up or drop-off location, and so on.

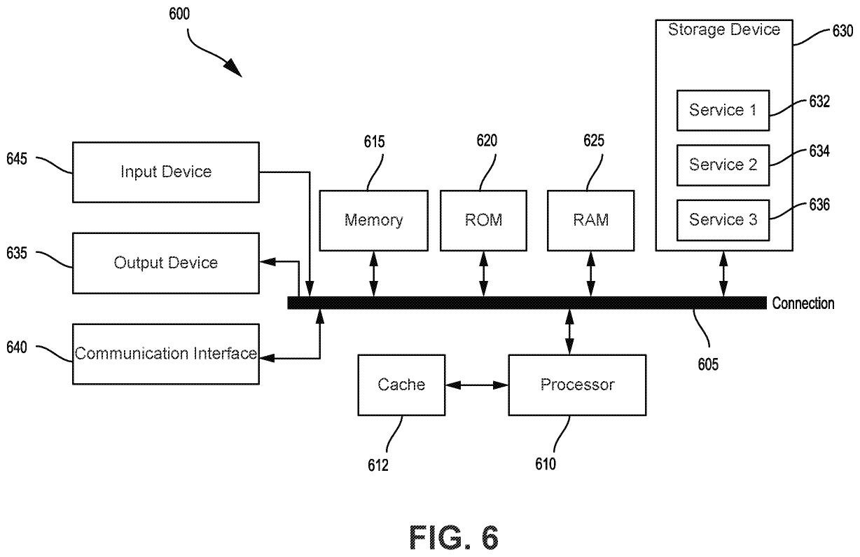

While the autonomous vehicle 102, the local computing device 110, and the autonomous vehicle environment 100 are shown to include certain systems and components, one of ordinary skill will appreciate that the autonomous vehicle 102, the local computing device 110, and/or the autonomous vehicle environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

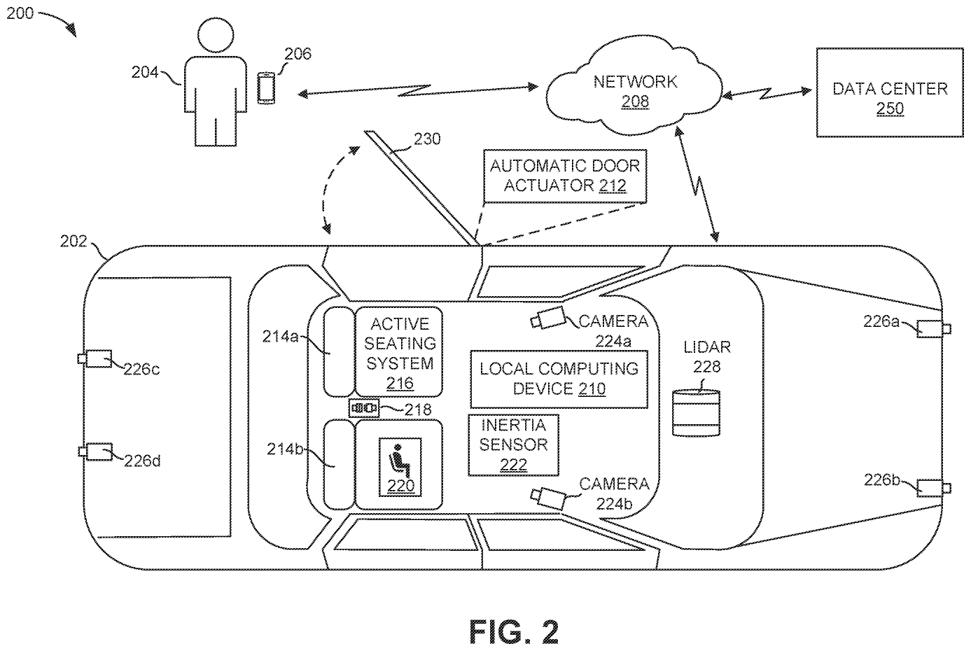

FIG. 2 illustrates an example system 200 for implementing automated door control in an autonomous vehicle (AV). In some aspects, system 200 can include AV 202. In some cases, AV 202 can include local computing device 210. In some examples, local computing device 210 can correspond to local computing device 110, as described in connection with FIG. 1. For example, local computing device 210 can include perception stack 112, localization stack 114, prediction stack 116, planning stack 118, and control stack 122.

In some cases, AV 202 may include automatic door actuator 212 that can be used for opening and closing one or more doors of AV 202. For example, automatic door actuator 212 may be used to open and close AV door 230. In some examples, automatic door actuator 212 may be coupled to local computing device 210. That is, local computing device 210 can send or transmit one or more signals or instructions for configuring automatic door actuator 212 to open or close one or more doors (e.g., AV door 230) of AV 202.

In some aspects, AV 202 can include one or more sensors (e.g., sensor systems 104-108 as illustrated in FIG. 1). For example, AV 202 can include seatbelt sensor 218 (e.g., detect when one or more seatbelts are fastened or unfastened); seat occupancy sensor 220 (e.g., detect when one or more seats are occupied); inertia sensor 222 (e.g., measure acceleration or angular rate using inertial measurement units (IMUs), gyroscopes, accelerometers, magnetometers, etc.); in-cabin cameras (e.g., camera 224a and camera 224b, collectively referred to as “cameras 224”); external cameras (e.g., camera 226a, camera 226b, camera 226c, and camera 226d, collectively referred to as “cameras 226”); and/or any other type of sensor.

In some cases, AV 202 can be configured to provide ridehailing services. For example, user 204 may request ridehailing service using client device 206. In some aspects, client device 206 can communicate with data center 250 and/or with AV 202 via network 208. In some instances, client device 206 may correspond to client computing device 170 that is configured to execute ridehailing app 172. In some examples, data center 250 may correspond to data center 150 (e.g., configured to execute ridehailing platform 160).

In some cases, AV 202 may be dispatched to a pick-up location for providing a ridehailing service to user 204. In some aspects, upon arriving at the pick-up location, AV 202 may use one or more sensors (e.g., external cameras 226, LIDAR 228, and/or any other AV sensor) to determine that AV 202 can safely pickup user 204. For example, AV 202 may use one or more sensors to identify an appropriate place to park that is clear of traffic. In some cases, AV 202 may use one or more AV sensors to determine whether AV door 230 can be safely opened. For instance, AV 202 may use cameras 226 to determine whether there are any objects that would collide with AV door 230 if it were opened.

Upon determining that AV door 230 can be safely opened (e.g., based on sensor data from one or more AV sensors), local computing device 210 may send a signal or command to automatic door actuator 212 to cause AV door 230 to open. In some cases, local computing device 210 may communicate directly with client device 206 via a wireless protocol such as Near-Field Communication (NFC), Bluetooth®, Ultra-Wide Band (UWB), Wi-Fi, and/or any other suitable wireless protocol. In some examples, AV 202 may cause AV door 230 to open upon determining that client device 206 is within a threshold distance (e.g., 3 meters) of AV 202.

In some cases, AV 202 may initiate a boarding timer upon opening AV door 230. For example, AV 202 may initiate a 30 second timer in which user 204 is expected to board AV 202. In some examples, the boarding timer may be based on the number of passengers expected for the ridehailing service. For instance, the request for the ridehailing service (e.g., from client device 206 or from data center 250) may provide an indication of the number of passengers that are to be picked up. In some aspects, a greater number of passengers may correspond to a larger boarding timer. For example, a ridehail service request for picking up 3 passengers may utilize a 60 second boarding timer. In some configurations, local computing device 210 may send a command to automatic door actuator 212 to close AV door 230 upon expiration of the boarding timer.

In some instances, AV 202 may use one or more AV sensors (e.g., cameras 224, cameras 226, LiDAR 228, etc.) to determine whether AV door 230 may be safely closed (e.g., when boarding timer has expired). For example, AV 202 may use cameras 226 to make sure that there are no objects, pedestrians, pets, etc. located near AV door 230 that would interfere with the closing process for AV door 230.

In some aspects, AV 202 may use one or more AV sensors to determine whether all passengers (e.g., user 204) are seated within AV 202. In one example, AV 202 may utilize seat occupancy sensor 220 to determine whether user 204 is seated within AV 202. In some cases, seat occupancy sensor 220 may correspond to a weight sensor, a capacitive sensor, an inductive sensor, and/or any other type of sensor for detecting that a person (e.g., user 204) is seated on AV seat 214a and/or AV seat 214b. In some cases, local computing device 210 may perform a “count” of the passengers by using the seat occupancy sensors associated with each seat. In some examples, local computing device 210 may confirm that the number of passengers seated match with the ridehail service request.

In another example, AV 202 may utilize seatbelt sensor 218 to determine whether all passengers (e.g., user 204) are seated within AV 202. For example, local computing device 210 can receive a signal from seatbelt sensor 218 indicating that the seatbelt associated with AV seat 214a and/or AV seat 214b has been fastened. In some cases, seatbelt sensor 218 may be used alone or in combination with seat occupancy sensor 220 to determine that AV door 230 may be closed (e.g., all passengers are seated within AV 202).

In another example, AV 202 may utilize in-cabin cameras (e.g., camera 224a and/or camera 224b) to determine whether all passengers (e.g., user 204) are seated within AV 202. For example, local computing device 210 can use images captured by cameras 224 to determine whether user 204 is seated on AV seat 214a and/or AV seat 214b. In some cases, camera images may be processed using a perception stack (e.g., perception stack 112) that is capable of identifying/classifying objects and/or determining a bounding box associated with an object. In some cases, camera images may be processed using a prediction stack (e.g., prediction stack 116) that can make predictions about an object or a person (e.g., predict position, trajectory, etc.). In some examples, cameras 224 may be used alone or in combination with seatbelt sensor 218 and/or seat occupancy sensor 220 to determine that AV door 230 may be closed (e.g., all passengers are seated within AV 202).

In another example, AV 202 may utilize inertia sensor 222 to determine whether all passengers (e.g., user 204) are seated within AV 202. For example, local computing device 210 can use data from an IMU (e.g., inertia sensor 222) to determine the movement of AV 202 as user 204 boards. That is, inertia sensor 222 can identify shifts in the position of AV 202 caused by passengers boarding. In some cases, inertia sensor 222 can determine when passengers have boarded based on the stability of AV 202. For example, local computing device 210 can examine time series data from inertia sensor 222 to identify when AV 202 is stable and determine that user 204 is seated. In some cases, local computing device 210 may analyze the time series data from inertia sensor 222 and identify peak values to determine that user 204 is seated. In some examples, local computing device 210 may transform the time series data from inertia sensor 222 to the frequency domain (e.g., using Fast Fourier Transform (FFT)) to decompose the time series data and identify one or more frequencies, frequency ranges, or harmonics that are indicative of a stable condition. In some aspects, inertia sensor 222 may be used alone or in combination with cameras 224, seatbelt sensor 218, and/or seat occupancy sensor 220 to determine that AV door 230 may be closed (e.g., all passengers are seated within AV 202).

In some cases, inertia sensor 222 may correspond to a single sensor (e.g., IMU) that is connected to the chassis of AV 202. In some aspects, inertia sensor 222 may correspond to multiple sensors that are placed at different locations of AV 202. In some examples, inertia sensor 222 may correspond to one or more IMUs that are associated with other AV sensors. For instance, one or more of cameras 224, cameras 226, or LiDAR 228 may have an inertia sensor such as an IMU. In some configurations, local computing device 210 can communicate with one or more of these inertia sensors to determine whether passengers (e.g., user 204) are seated within AV 202.

In some aspects, one or more of the seats (e.g., AV seat 214a and/or AV seat 214b) in AV 202 may correspond to an active suspension seat that may be controlled by an active seating system 216. In some cases, active seating systems 216 may include a seat sensor system, a seat control system, and/or a seat actuator system. For example, active seating system 216 may include IMUs, gyroscopes, accelerometers, magnetometers, pressure sensors, weight sensors, etc. In some instances, active seating system 216 may include a controller or processor that can provide a communication interface between AV 202 and active seating system 216. In some cases, active seating system 216 may include electrical components, mechanical components, and/or electromechanical components that may be used to effectuate movement of AV seat 214a and/or AV seat 214b. For example, active seating system 216 may include rods, axles, pistons, cylinders, valves, rollers, springs, fasteners, wiring, electric actuators, hydraulic actuators, pneumatic actuators, linear motors, rotary motors, any other component, and/or any combination thereof.

In some cases, AV 202 may utilize active seating system 216 to determine whether all passengers (e.g., user 204) are seated within AV 202. For example, local computing device 210 may receive data from active seating system 216 that indicates whether a passenger is seated on the corresponding seat (e.g., AV seat 214a or AV seat 214b). In some aspects, the data from active seating system 216 may correspond to IMU data (e.g., linear acceleration and/or rotational acceleration). In some aspects, active seating system 216 may be used alone or in combination with inertia sensor 222, cameras 224, seatbelt sensor 218, and/or seat occupancy sensor 220 to determine that AV door 230 may be closed (e.g., all passengers are seated within AV 202).

In some aspects, AV 202 may utilize one or more AV sensors to determine whether a passenger (e.g., user 204) is asleep. In one example, AV 202 may utilize active seating system 216 (e.g., IMU) to determine whether user 204 is asleep (e.g., based on movement or lack of movement of AV seat 214a or AV seat 214b). In another example, AV 202 may use inertia sensor 222 (e.g., IMU external to active seating system 216) to determine whether user 204 is asleep. In another example, AV 202 may use in-cabin cameras (e.g., camera 224a and/or camera 224b) to determine whether user 204 is asleep. For example, image data captured by cameras 224 can be processed by a machine learning algorithm (e.g., perception stack 112) to determine that user 204 is asleep. In another example, AV 202 may determine that user 204 is asleep based on data received from client device 206. For instance, client device 206 may correspond to a smart watch that can use sensors (e.g., gyroscope, accelerometer, etc.) to sense movement of user 204 and determine whether user 204 is asleep.

In some configurations, AV 202 may generate an alert for waking user 204 prior to arriving at the destination. That is, AV 202 may ensure that user 204 is awake prior to sending a command to open AV door 230. In some cases, the alert for waking user 204 may include adjusting the volume setting (e.g., increasing volume) of in-cabin entertainment. In another example, the alert for waking user 204 may include activation of an odorization system (not illustrated) within the cabin of AV 202. In another example, the alert for waking user 204 may include turning on the lights within the cabin of AV 202. In another example, the alert for waking user 204 may include causing AV seat 214a or AV seat 214b to vibrate by sending a command to active seating system 216. In another example, the alert for waking user 204 may include sending a message to client device 206 (e.g., client device 206 may vibrate, generate an alarm, turn on music, etc.).

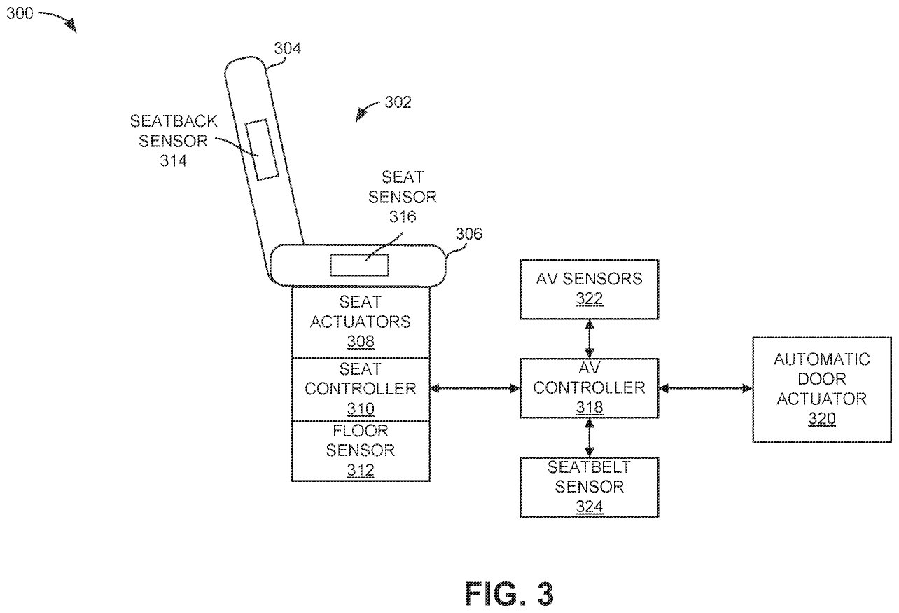

FIG. 3 illustrates an example system 300 for an active seating system that may be used for implementing automated door control in an autonomous vehicle. In some aspects, system 300 can include AV seat 302 having a seatback 304 and a seat bottom 306. In some cases, AV seat 302 can be coupled to an active seating system that can include seat actuators 308 and seat controller 310. In some aspects, seat controller 310 can interface and control seat actuators 308 to make AV seat 302 move in one or more directions (e.g., upward direction, downward direction, leftward direction, rightward direction, frontward direction, backward direction, pitch direction, roll direction, and/or yaw direction).

In some aspects, seat controller 310 can be communicatively coupled to AV controller 318 (e.g., local computing device 110). In some examples, AV controller 318 can send instructions to seat controller 310 to cause AV seat 302 to move in one or more directions. For example, if an AV determines that a passenger is asleep, the AV may send instructions to seat controller 310 to cause AV seat 302 to move in order to wake the passenger prior to arriving at a destination and/or prior to opening an automated AV door.

In some examples, AV seat 302 can include one or more sensors such as a floor sensor 312, a seatback sensor 314, and a seat sensor 316. In some aspects, floor sensor 312, seatback sensor 314, and seat sensor 316 can correspond to inertial measurement units (IMUs). In some cases, each of the floor sensor 312, seatback sensor 314, and seat sensor 316 can be configured to measure linear acceleration as well as angular rates. In some cases, the linear acceleration and/or the angular rates measured using the active seating system sensors (e.g., floor sensor 312, seatback sensor 314, and/or seat sensor 316) can be used to determine whether a passenger is seated on AV seat 302 and/or whether a passenger is asleep.

In some examples, AV controller 318 can also be coupled to one or more AV sensors 322 (e.g., camera sensor, LiDAR sensors, RADAR sensors, IMUs, etc.) and seatbelt sensor 324. In some cases, AV controller 318 can use the data from AV sensors 322 and/or seatbelt sensor 324 together with the data received from seat controller 310 (e.g., corresponding to floor sensor 312, seatback sensor 314, and/or seat sensor 316) to determine whether a passenger is seated on AV seat 302. In some instances, AV controller 318 may send an instruction to automatic door actuator 320 for closing one or more AV doors when AV controller 318 determines that passengers are seated within the AV.

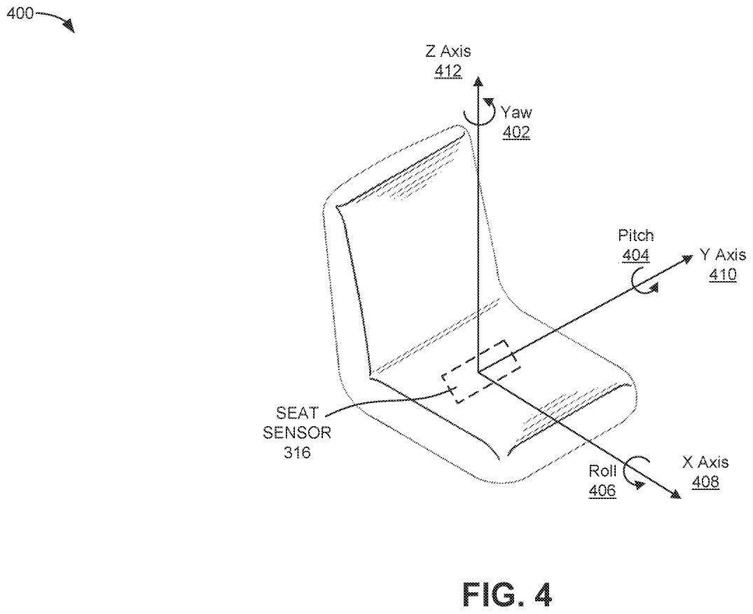

FIG. 4 illustrates an example of measurements that may be obtained from AV seat 400. As illustrated, AV seat 400 includes seat sensor 316 that is positioned at or near the seat cushion (the floor sensor 312 and seatback sensor 314 are not illustrated in FIG. 4 but may perform same or similar operations).

In some aspects, seat sensor 316 can be used to measure linear acceleration along X-axis 408, Y-axis 410, and/or Z-axis 412. In some cases, seat sensor 316 may be used to measure angular acceleration in the yaw 402 direction, the pitch 404 direction, and/or the roll 406 direction. In some examples, the measurements from seat sensor 316 (as well as floor sensor 312 and seatback sensor 314) can be used to determine whether a passenger is seated on AV seat 400. For example, upon entering the vehicle, measurements from seat sensor 316 may indicate a relatively high rate of movement as the passenger maneuvers and becomes comfortable on AV seat 400. Once the passenger is seated, measurements from seat sensor 316 may indicate a reduced rate of movement. In some aspects, measurements from seat sensor 316 may further be used to determine that a passenger has fallen asleep.

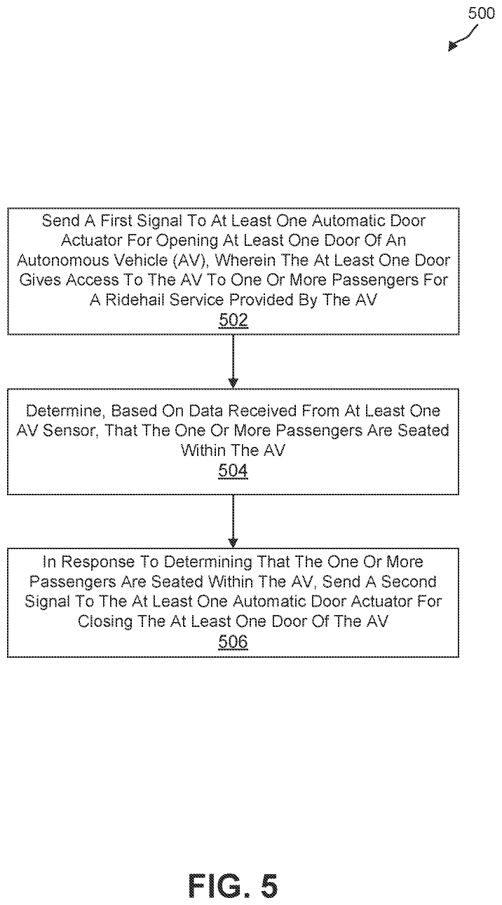

FIG. 5 illustrates an example of a process 500 for controlling an active seating system in an autonomous vehicle (AV). At block 502, the process 500 includes sending a first signal to at least one automatic door actuator for opening at least one door of an autonomous vehicle (AV), wherein the at least one door gives access to the AV to one or more passengers for a ridehail service provided by the AV. For example, local computing device 210 can send a signal to automatic door actuator 212 for opening AV door 230 of AV 202.

At block 504, the process 500 includes determining, based on data received from at least one AV sensor, that the one or more passengers are seated within the AV. For instance, local computing device 210 can determine that user 204 is seated within AV 202 based on data received from active seating system 216, seatbelt sensor 218, seat occupancy sensor 220, inertia sensor 222, cameras 224, cameras 226, and/or LiDAR 228.

At block 506, the process 500 includes in response to determining that the one or more passengers are seated within the AV, sending a second signal to the at least one automatic door actuator for closing the at least one door of the AV. For instance, local computing device 210 can send a signal to automatic door actuator 212 for closing AV door 230.

In some aspects, the at least one AV sensor can comprise one or more seat occupancy sensors and determining that the one or more passengers are seated within the AV can include receiving a request for the ridehail service provided by the AV, wherein the request includes a number of the one or more passengers and determining, based on the data received from the one or more seat occupancy sensors, that a quantity of occupied seats in the AV corresponds to the number of the one or more passengers. For example, the one or more AV sensor can correspond to seat occupancy sensor 220. In some aspects, AV 202 can receive a request from data center 250 for ridehail service and the request can include a number of passengers. In some cases, AV 202 can determine that the number of occupied seats in the AV corresponds to the number of passengers from the ridehail service request based on data from seat occupancy sensor 220.

In some examples, the at least one AV sensor can comprise one or more seatbelt sensors and determining that the one or more passengers are seated within the AV can include receiving a request for the ridehail service provided by the AV, wherein the request includes a number of the one or more passengers and determining, based on the data received from the one or more seatbelt sensors, that a quantity of fastened seatbelts in the AV corresponds to the number of the one or more passengers. For example, the one or more AV sensor can correspond to seatbelt sensor 218. In some aspects, AV 202 can receive a request from data center 250 for ridehail service and the request can include a number of passengers. In some cases, AV 202 can determine that the number of fastened seatbelts in the AV corresponds to the number of passengers from the ridehail service request based on data from seatbelt sensor 218.

In some instances, the at least one AV sensor can comprise one or more cameras, and the process 500 can further include: processing the data received from the one or more cameras using a perception stack of the AV and determining, based on an output of the perception stack, that the one or more passengers are seated within the AV. For example, the one or more sensors can correspond to one or more in-cabin cameras (e.g., camera 224a and/or camera 224b). In some aspects, data received from the in-cabin cameras can be processed using perception stack 112 and local computing device 210 can determine that user 204 is seated on AV seat 214a or AV seat 214b based on the output of the perception stack 112.

In some configurations, the at least one AV sensor can comprise one or more inertial measurement units (IMUs), and the process 500 can further include: detecting, based on the data from the one or more IMUs, a movement of the AV as the one or more passengers enter the AV and determining, based on the data from the one or more IMUs, that the movement of the AV has settled to a threshold level, wherein the threshold level indicates that the one or more passengers are seated within the AV. For example, the at least one AV sensor can correspond to inertia sensor 222, seat sensor 316, floor sensor 312, seatback sensor 314, etc. In some aspects, the IMU (e.g., inertia sensor 222) can be used to detect a movement of AV 202 as user 204 enters AV 202. In some cases, the IMU (e.g., inertia sensor 222) can be used to determine that the movement of the AV has settled to a threshold level indicating that user 204 is seated within AV 202. In some examples, the one or more IMUs are associated with one or more cameras. For example, the one or more IMUs may be associated with (e.g., coupled to) cameras 224 and/or cameras 226. In some cases, the one or more IMUs are associated with an active seating system (e.g., active seating system 216).

In some example, the process 500 can further include initiating a boarding timer after sending the first signal to the at least one automatic door actuator for opening the at least one door of the AV and providing an alert to the one or more passengers upon expiration of the boarding timer, wherein the alert precedes the second signal to the at least one automatic door actuator for closing the at least one door of the AV. For example, local computing device 210 can initiate a boarding timer after sending the signal to automatic door actuator 212 that causes AV door 230 to open. In some cases, local computing device 210 can provide an alert upon expiration of the boarding timer. In some examples, the alert can indicate that AV door 230 is about to be closed.

In some cases, the at least one AV sensor can comprise one or more IMUs and the process 500 can further include: determining that the AV is within a threshold distance of a final destination associated with the ridehail service; determining, based on IMU sensor data from the one or more IMUs, that at least one passenger of the one or more passengers is asleep while the AV is within the threshold distance of the final destination; and in response to determining that the at least one passenger is asleep, providing a wake-up alert to the at least one passenger. For example, local computing device 210 can determine that AV 202 is within a threshold distance (e.g., 1 mile) of a final destination associated with the ridehail service for user 204. In some cases, local computing device 210 can determine, based on IMU sensor data (e.g., data from inertia sensor 222 or from active seating system 216), that user 204 is asleep while AV 202 is within a threshold distance of the final destination. In some cases, local computing device 210 can provide a wake-up alert to user 204 prior to arriving at the final destination and/or prior to opening AV door 230. In some cases, the wake-up alert can be a vibration of AV seat 214a or AV seat 214b that is caused by using active seating system 216.

In some examples, the process 500 can include determining, based on IMU sensor data from the one or more IMUs, that the at least one passenger is awake; and in response to arriving at the final destination, sending a third signal to the at least one automatic door actuator for opening the at least one door of the AV. For example, local computing device 210 can use sensor data (e.g., from inertia sensor 222 or active seating system 216) to determine that user 204 is awake. In some aspects, local computing device 210 can send a signal to automatic door actuator 212 causing AV door 230 to open upon arriving at the final destination.

FIG. 6 illustrates an example processor-based system with which some aspects of the subject technology can be implemented. For example, processor-based system 600 can be any computing device making up internal computing system 110, a passenger device executing the ridesharing application 172, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some examples, computing system 600 is a distributed system in which the functions described in this disclosure can be distributed within a datacenter, multiple data centers, a peer network, etc. In some cases, one or more of the described system components represents many such components each performing some or all of the function for which the component is described. In some aspects, the components can be physical or virtual devices.

Example system 600 includes at least one processing unit (CPU or processor) 610 and connection 605 that couples various system components including system memory 615, such as read-only memory (ROM) 620 and random-access memory (RAM) 625 to processor 610. Computing system 600 can include a cache of high-speed memory 612 connected directly with, in close proximity to, and/or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 can include an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple R; Lightning R port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACONR; wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory StickR card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L #), resistive random-access memory (RRAM/ReRAM), phase change memory (PCM), spin transfer torque RAM (STT-RAM), another memory chip or cartridge, and/or a combination thereof.

Storage device 630 can include software services, servers, services, etc., that when the code that defines such software is executed by the processor 610, causes the system to perform a function. In some examples, a hardware service that performs a particular function can include the software component stored in a computer-readable medium in connection with the necessary hardware components, such as processor 610, connection 605, output device 635, etc., to carry out the function.

As understood by those of skill in the art, machine-learning techniques can vary depending on the desired implementation. For example, machine-learning schemes can utilize one or more of the following, alone or in combination; hidden Markov models: recurrent neural networks; convolutional neural networks (CNNs); deep learning: Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of; a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

### Selected Examples

### Illustrative Examples of the Disclosure Include

Aspect 1. A method comprising: sending a first signal to at least one automatic door actuator for opening at least one door of an autonomous vehicle (AV), wherein the at least one door gives access to the AV to one or more passengers for a ridehail service provided by the AV; determining, based on data received from at least one AV sensor, that the one or more passengers are seated within the AV; and in response to determining that the one or more passengers are seated within the AV, sending a second signal to the at least one automatic door actuator for closing the at least one door of the AV.
Aspect 2. The method of Aspect 1, wherein the at least one AV sensor comprises one or more seat occupancy sensors, and wherein determining that the one or more passengers are seated within the AV further comprises: receiving a request for the ridehail service provided by the AV, wherein the request includes a number of the one or more passengers; and determining, based on the data received from the one or more seat occupancy sensors, that a quantity of occupied seats in the AV corresponds to the number of the one or more passengers.
Aspect 3. The method of any of Aspects 1 to 2, wherein the at least one AV sensor comprises one or more seatbelt sensors, and wherein determining that the one or more passengers are seated within the AV further comprises: receiving a request for the ridehail service provided by the AV, wherein the request includes a number of the one or more passengers; and determining, based on the data received from the one or more seatbelt sensors, that a quantity of fastened seatbelts in the AV corresponds to the number of the one or more passengers.
Aspect 4. The method of any of Aspects 1 to 3, wherein the at least one AV sensor comprises one or more cameras, the method further comprising: processing the data received from the one or more cameras using a perception stack of the AV; and determining, based on an output of the perception stack, that the one or more passengers are seated within the AV.
Aspect 5. The method of any of Aspects 1 to 4, wherein the at least one AV sensor comprises one or more inertial measurement units (IMUs), the method further comprising: detecting, based on the data from the one or more IMUs, a movement of the AV as the one or more passengers enter the AV; and determining, based on the data from the one or more IMUs, that the movement of the AV has settled to a threshold level, wherein the threshold level indicates that the one or more passengers are seated within the AV.
Aspect 6. The method of Aspect 5, wherein the one or more IMUs are associated with one or more camera sensors or with an active seating system.
Aspect 7. The method of any of Aspects 1 to 6, further comprising: initiating a boarding timer after sending the first signal to the at least one automatic door actuator for opening the at least one door of the AV; and providing an alert to the one or more passengers upon expiration of the boarding timer, wherein the alert precedes the second signal to the at least one automatic door actuator for closing the at least one door of the AV.
Aspect 8. The method of any of Aspects 1 to 7, wherein the at least one AV sensor comprises one or more inertial measurement units (IMUs), the method further comprising: determining that the AV is within a threshold distance of a final destination associated with the ridehail service; determining, based on IMU sensor data from the one or more IMUs, that at least one passenger of the one or more passengers is asleep while the AV is within the threshold distance of the final destination; and in response to determining that the at least one passenger is asleep, providing a wake-up alert to the at least one passenger.
Aspect 9. The method of Aspect 8, further comprising: determining, based on IMU sensor data from the one or more IMUs, that the at least one passenger is awake; and in response to arriving at the final destination, sending a third signal to the at least one automatic door actuator for opening the at least one door of the AV.
Aspect 10. An autonomous vehicle comprising: at least one automatic door actuator; at least one sensor; at least one memory; and at least one processor coupled to the at least one memory, the at least one sensor, and the at least one automatic door actuator, wherein the at least one processor is configured to perform operations in accordance with any one of Aspects 1 to 9.
Aspect 11. An apparatus comprising means for performing operations in accordance with any one of Aspects 1 to 9.
Aspect 12. A non-transitory computer-readable medium comprising instructions that, when executed by an apparatus, cause the apparatus to perform operations in accordance with any one of Aspects 1 to 9.

The various examples described above are provided by way of illustration only and should not be construed to limit the scope of the disclosure. For example, the principles herein apply equally to optimization as well as general improvements. Various modifications and changes may be made to the principles described herein without following the examples and applications illustrated and described herein, and without departing from the scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A. B. or A and B. and can additionally include items not listed in the set of A and B.

What is claimed is:

1. An autonomous vehicle (AV) comprising:
at least one automatic door actuator:
at least one inertial measurement unit (IMU);
at least one memory comprising instructions; and
at least one processor coupled to the at least one automatic door actuator, the at least one IMU, and the at least one memory, wherein the at least one processor is configured to:
send a first signal to the at least one automatic door actuator for opening at least one door of the AV, wherein the at least one door gives access to the AV to one or more passengers for a ridehail service provided by the AV:
detect, based on a first set of data received from the at least one IMU, a movement of the AV as the one or more passengers enter the AV:
determine, based on a second set of data received from the at least one IMU, that the movement of the AV has settled to a threshold level, wherein the threshold level indicates that the one or more passengers are seated within the AV: and
in response to determining that the one or more passengers are seated within the AV, send a second signal to the at least one automatic door actuator for closing the at least one door of the AV.

2. The AV of claim 1, further comprising:
at least one seat occupancy sensor coupled to the at least one processor, wherein the at least one processor is further configured to:
receive a request for the ridehail service provided by the AV, wherein the request includes a number of the one or more passengers; and
determine, based on data received from the at least one seat occupancy sensor, that a quantity of occupied seats in the AV corresponds to the number of the one or more passengers.

3. The AV of claim 1, further comprising:
at least one seatbelt sensor coupled to the at least one processor, wherein the at least one processor is further configured to:
receive a request for the ridehail service provided by the AV, wherein the request includes a number of the one or more passengers; and
determine, based on data received from the at least one seatbelt sensor, that a quantity of fastened seatbelts in the AV corresponds to the number of the one or more passengers.

4. The AV of claim 1, further comprising:
at least one camera coupled to the at least one processor, wherein the at least one processor is further configured to:
process data received from the at least one camera using a perception stack of the AV; and
determine, based on an output of the perception stack, that the one or more passengers are seated within the AV.

5. The AV of claim 1, wherein the at least one IMU includes a plurality of IMUs that are associated with one or more camera sensors, wherein the one or more camera sensors are coupled to the at least one processor.

6. The AV of claim 1, wherein the at least one IMU is associated with an active seating system, wherein the active seating system is coupled to the at least one processor.

7. The AV of claim 1, wherein the at least one processor is further configured to:
initiate a boarding timer after sending the first signal to the at least one automatic door actuator for opening the at least one door of the AV; and
provide an alert to the one or more passengers upon expiration of the boarding timer, wherein the alert precedes the second signal to the at least one automatic door actuator for closing the at least one door of the AV.

8. The AV of claim 1, wherein the at least one processor is further configured to:
determine that the AV is within a threshold distance of a final destination associated with the ridehail service:
determine, based on IMU sensor data from the at least one IMU, that at least one passenger of the one or more passengers is asleep while the AV is within the threshold distance of the final destination; and
in response to determining that the at least one passenger is asleep, provide a wake-up alert to the at least one passenger.

9. The AV of claim 8, wherein the at least one processor is further configured to:
determine, based on IMU sensor data from the at least one IMU, that the at least one passenger is awake; and
in response to arriving at the final destination, send a third signal to the at least one automatic door actuator for opening the at least one door of the AV.

10. A method comprising:
sending a first signal to at least one automatic door actuator for opening at least one door of an autonomous vehicle (AV), wherein the at least one door gives access to the AV to one or more passengers for a ridehail service provided by the AV:
detecting, based on a first set of data received from at least one inertial measurement unit (IMU), a movement of the AV as the one or more passengers enter the AV:
determining, based on a second set of data received from the at least one IMU, that the movement of the AV has settled to a threshold level, wherein the threshold level indicates that the one or more passengers are seated within the AV; and
in response to determining that the one or more passengers are seated within the AV, sending a second signal to the at least one automatic door actuator for closing the at least one door of the AV.

11. The method of claim 10, further comprising:
receiving a request for the ridehail service provided by the AV, wherein the request includes a number of the one or more passengers; and
determining, based on data received from at least one seat occupancy sensor, that a quantity of occupied seats in the AV corresponds to the number of the one or more passengers.

12. The method of claim 10, further comprising:
receiving a request for the ridehail service provided by the AV, wherein the request includes a number of the one or more passengers; and
determining, based on data received from at last one seatbelt sensor, that a quantity of fastened seatbelts in the AV corresponds to the number of the one or more passengers.

13. The method of claim 10, further comprising:
processing data received from at least one camera using a perception stack of the AV; and
determining, based on an output of the perception stack, that the one or more passengers are seated within the AV.

14. The method of claim 10, wherein the at least one IMU includes a plurality of IMUs that are associated with one or more camera sensors, wherein the one or more camera sensors are coupled to the AV.

15. The method of claim 10, further comprising:
initiating a boarding timer after sending the first signal to the at least one automatic door actuator for opening the at least one door of the AV; and
providing an alert to the one or more passengers upon expiration of the boarding timer, wherein the alert precedes the second signal to the at least one automatic door actuator for closing the at least one door of the AV.

16. The method of claim 10, further comprising:
determining that the AV is within a threshold distance of a final destination associated with the ridehail service:
determining, based on IMU sensor data from the at least one IMU, that at least one passenger of the one or more passengers is asleep while the AV is within the threshold distance of the final destination; and
in response to determining that the at least one passenger is asleep, providing a wake-up alert to the at least one passenger.

17. The method of claim 16, further comprising:
determining, based on IMU sensor data from the at least one IMU, that the at least one passenger is awake; and
in response to arriving at the final destination, sending a third signal to the at least one automatic door actuator for opening the at least one door of the AV.

18. A non-transitory computer-readable storage medium having stored thereon instructions which, when executed by one or more processors, cause the one or more processors to:
send a first signal to at least one automatic door actuator for opening at least one door of an autonomous vehicle (AV), wherein the at least one door gives access to the AV to one or more passengers for a ridehail service provided by the AV:
detect, based on a first set of data received from at least one IMU, a movement of the AV as the one or more passengers enter the AV:
determine, based on a second set of data received from the at least one IMU, that the movement of the AV has settled to a threshold level, wherein the threshold level indicates that the one or more passengers are seated within the AV; and
in response to determining that the one or more passengers are seated within the AV, send a second signal to the at least one automatic door actuator for closing the at least one door of the AV.

19. The non-transitory computer-readable storage medium of claim 18, comprising further instructions to cause the one or more processors to:
determine that the AV is within a threshold distance of a final destination associated with the ridehail service:
determine, based on IMU sensor data from the at least one IMU, that at least one passenger of the one or more passengers is asleep while the AV is within the threshold distance of the final destination; and
in response to determining that the at least one passenger is asleep, provide a wake-up alert to the at least one passenger.

20. The non-transitory computer-readable storage medium of claim 19, comprising further instructions to cause the one or more processors to:
determine, based on IMU sensor data from the at least one IMU, that the at least one passenger is awake; and
in response to arriving at the final destination, send a third signal to the at least one automatic door actuator for opening the at least one door of the AV.
